(19) United States
(12) Patent Application Publication
(10) Pub. No.: US 2026/0195466 A1
(43) Pub. Date: Jul. 9, 2026

(54) ZERO CHANGED FILE TRUST HARDENING OF ENDPOINT COMPUTING DEVICES

(71) Applicant: Sophos Limited, Abingdon (GB)

(72) Inventors: Nikolay I. Nikolaev, Abingdon (GB); Rade Todorovic, Abingdon (GB); Naveed Awais, Coventry (GB)

(21) Appl. No.: 19/011,263

(22) Filed: Jan. 6, 2025

(51) Int. Cl. G06F 21/62

(52) U.S. Cl. CPC G06F 21/6218; G06F 21/50; G06F 21/51; G06F 21/566; G06F 21/71

(57) ABSTRACT

Methods, systems, and computer program products for hardening an endpoint computing device include initiating detection of file change operations and detection of file execution operations on an endpoint device. When a file change operation is detected, attributes associated with a process that initiated the file change operation are identified, attributes associated with the file change operation are identified, and the attributes are stored in a changed file list. When a file execution operation is detected, a file in the changed file list that corresponds to a file associated with the file execution operation is identified, and whether to prevent execution of the file is determined by applying a security policy to the one or more attributes in the changed file list that correspond to the identified file.

### TECHNICAL FIELD

The subject matter of the technology described herein relates generally to methods, systems, and computer program products for zero changed file trust hardening of endpoint computing devices.

### BACKGROUND

Application allowlisting (also called whitelisting) is a popular technique for enhancing the security of computing devices by allowing only vetted and approved applications to run on the device. While conceptually simple and straightforward, application allowlisting techniques are known to be notoriously difficult and laborious to operate and maintain.

A typical application allowlisting procedure involves scanning all disks of the computing device to build an allowed list (e.g., file paths and content checksums) of executables as a first “known good state.” In some implementations, this scanning process can take up to several hours to complete. After that, the application allowlisting procedure tries to track all executable file operations (i.e., create new, update, rename and delete) performed by operating system processes and update the corresponding items in the allowed list. This type of change tracking is very complex and not always reliable. For example, the allowed list can go out of sync and the allowlisting procedure may start blocking legitimate applications. When this happens, one workaround is to unlock the computing device and initiate another time-consuming lock process to re-generate the allowed list.

### SUMMARY

In general, to overcome the above-identified deficiencies, it may be beneficial to provide methods, systems, and computer program products that harden computing devices, such as endpoint computing devices, against malicious activity related to unauthorized file change operations and unauthorized file execution operations by implementing a zero changed file trust framework. This framework begins tracking executable file changes on a computing device according to a defined security policy and builds a list of changed files over time, without requiring any initial scanning or whitelisting of the computing device. Any subsequent attempts to execute files that are on the changed list are blocked unless otherwise authorized by the applicable security policy. In addition, unlocking and relocking the computing device (e.g., for device maintenance procedures) simply involves clearing and resetting the changed file list. As a result, the changed file list does not require constant updates that may result in desynchronization and unintended blocking of legitimate applications.

As can be appreciated, the zero changed file trust framework described herein can be particularly applicable to endpoint computing devices (e.g., point-of-sale (PoS) terminals, golden images) where file change operations are undesirable or restricted. The framework can also be temporarily applied to computing devices that are suspected to be compromised, in a vulnerable state, or under attack as a means of preventing, slowing down, or disrupting malicious activity.

In general, in an aspect, a system for hardening an endpoint computing device may include one or more computer-readable media having computer-executable instructions stored thereon; and one or more processors that, having executed the computer-executable instructions, are configured to: initiate detection of file change operations and detection of file execution operations in an operating system on an endpoint computing device; when a file change operation is detected: identify one or more attributes associated with a process that initiated the file change operation, identify one or more attributes associated with the file change operation, the attributes including a unique file id associated with the changed file, store the one or more attributes associated with the file change operation in a changed file list; and when a file execution operation is detected: identify a file in the changed file list that corresponds to a file associated with the file execution operation, and determine whether to prevent execution of the file by applying a security policy to the one or more attributes in the changed file list that correspond to the identified file.

In general, in an aspect, a method for hardening an endpoint computing device may include initiating detection of file change operations and detection of file execution operations in an operating system on an endpoint computing device; when a file change operation is detected: identifying one or more attributes associated with a process that initiated the file change operation, identifying one or more attributes associated with the file change operation, the attributes including a unique file id associated with the changed file, storing the one or more attributes associated with the file change operation in a changed file list; and when a file execution operation is detected: identifying a file in the changed file list that corresponds to a file associated with the file execution operation, and determining whether to prevent execution of the file by applying a security policy to the one or more attributes in the changed file list that correspond to the identified file.

In some implementations, the file change operations comprise creating a file, modifying a file, renaming a file, moving a file, deleting a file, renaming a folder, moving a folder, and creating a hardlink. In some implementations, the one or more attributes associated with the file change operation further comprise one or more of: a file format of the changed file, a file path of the changed file, a folder path of the changed file, a checksum of the changed file, and a reputation score of the changed file. In some implementations, the file format of the changed file comprises a Portable Executable (PE) file format. In some implementations, the one or more attributes associated with the process that initiated the file change operation comprise one or more of: a file path of the process that initiated the file change operation, a folder path of the process that initiated the file change operation, a checksum of the process that initiated the file change operation, an identification of one or more other processes related to the process that initiated the file change operation.

In some implementations, the endpoint computing device receives the security policy from a remote policy administration computing device for storage in a policy store on the endpoint computing device. In some implementations, the endpoint computing device transmits one or more events associated with the detection of file change operations to the remote policy administration computing device, and the endpoint computing device allows the file change operation and/or allow the file execution operation based upon instructions received from the remote policy administration computing device.

In some implementations, the endpoint computing device initiates one of a plurality of operational modes, each operational mode comprising one or more rules for adjusting the detection of file change operations or adjusting the detection of file execution operations. In some implementations, the operational modes comprise a block all file changes mode, a block unauthorized file changes mode, a block unauthorized file executions mode, a monitoring mode, and a maintenance mode. In some implementations, when one or more other protection layers on the endpoint computing device detect a threat on the endpoint computing device, the endpoint automatically initiates the block all file changes mode until the threat is resolved. In some implementations, upon initiation of the maintenance mode, the endpoint computing device suspends the detection of file change operations and prevents new files from being added to the changed file list. In some implementations, one or more other system protection layers on the endpoint computing device automatically increase a level of protection for the endpoint computing device upon initiation of the maintenance mode.

Other aspects and advantages of the technology will become apparent from the following detailed description, taken in conjunction with the accompanying drawings, illustrating the principles of the technology by way of example only.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 illustrates a system for enterprise network threat detection, according to one example embodiment.

FIG. 2 illustrates a threat management system, according to one example embodiment.

FIG. 3 illustrates a block diagram of an endpoint computing device according to embodiments.

FIG. 4 illustrates a detailed block diagram of an endpoint computing device according to embodiments.

FIG. 5 illustrates a flow diagram of a method for hardening an endpoint computing device, according to one embodiment.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

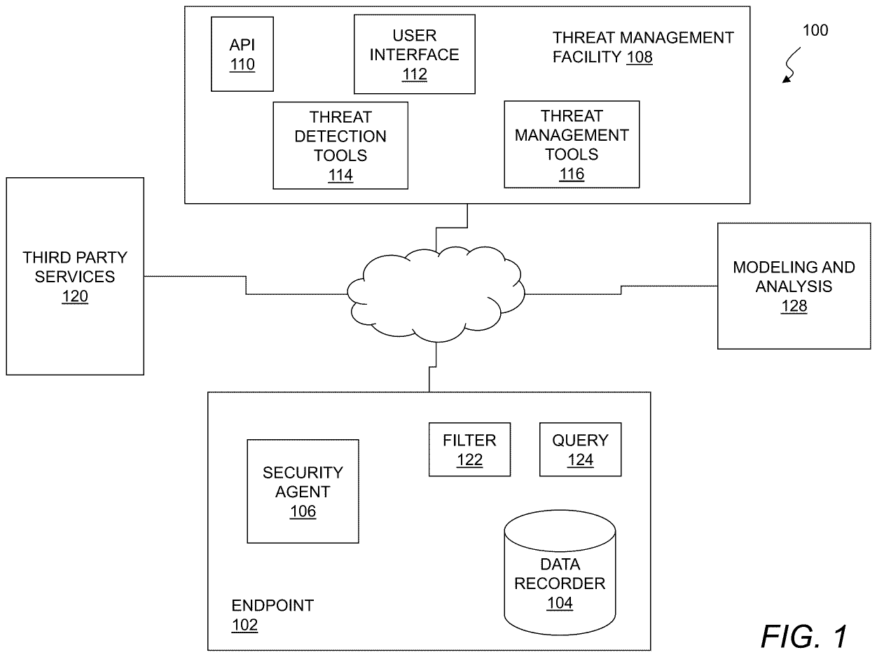

FIG. 1 shows a system 100 for enterprise network threat detection. In the system, a number of endpoint computing devices, such as endpoint 102, may log events in a data recorder 104. A local agent on the endpoint 102 such as the security agent 106 may filter this data and feed a filtered data stream to a threat management facility 108 such as a central threat management facility. The threat management facility 108 can locally or globally tune filtering by local agents based on the current data stream and can query local event data recorders for additional information where necessary or helpful in threat detection or forensic analysis. The threat management facility 108 may also or instead store and deploys a number of security tools such as a web-based user interface that is supported by machine learning models to aid in the identification and assessment of potential threats by a human user. This may, for example, include machine learning analysis of new code samples, models to provide human-readable context for evaluating potential threats, and any of the other tools or techniques described herein. More generally, the threat management facility 108 may provide any of a variety of threat detection tools 114 and/or threat management tools 116 to aid in the detection, evaluation, and remediation of threats or potential threats.

The threat management facility 108 may perform a range of threat management functions such as any of those described herein. The threat management facility 108 may generally include an application programming interface 110 to third party services 120, a user interface 112 for access to threat management and network administration functions, and a number of threat detection tools 114 and threat management tools 116.

In general, the application programming interface 110 may support programmatic connections with third party services 120. The application programming interface 110 may, for example, connect to Active Directory or other customer information about files, data storage, identities and user profiles, roles, access privileges and so forth. More generally, the application programming interface 110 may provide a programmatic interface for customer or other third-party context, information, administrative, and security tools, and so forth. The application programming interface 110 may also or instead provide a programmatic interface for hosted applications, identity provider integration tools or services, and so forth.

The user interface 112 may include a website or other graphical interface or the like and may generally provide an interface for user interaction with the threat management facility 108, e.g., for threat detection, network administration, audit, configuration and so forth. This user interface 112 may generally facilitate human curation of intermediate threats as contemplated herein, e.g., by presenting intermediate threats along with other supplemental information, and providing controls for user to dispose of such intermediate threats as desired, e.g., by permitting execution or access, by denying execution or access, or by engaging in remedial measures such as sandboxing, quarantining, vaccinating, and so forth.

The threat detection tools 114 may be any of the threat detection tools, algorithms, techniques or the like described herein, or any other tools or the like useful for detecting threats or potential threats within an enterprise network. This may, for example, include signature-based tools, behavioral tools, machine learning models, and so forth. In general, the threat detection tools 114 may use event data provided by endpoints within the enterprise network, as well as any other available context such as network activity, heartbeats, and so forth to detect malicious software or potentially unsafe conditions for a network or endpoints connected to the network. In one aspect, the threat detection tools 114 may usefully integrate event data from a number of endpoints (including, e.g., network components such as gateways, routers, and firewalls) for improved threat detection in the context of complex or distributed threats. The threat detection tools 114 may also or instead include tools for reporting to a separate modeling and analysis platform 128, e.g., to support further investigation of security issues, creation or refinement of threat detection models or algorithms, review and analysis of security breaches, and so forth.

The threat management tools 116 may generally be used to manage or remediate threats to the enterprise network that have been identified with the threat detection tools 114 or otherwise. Threat management tools 116 may, for example, include tools for sandboxing, quarantining, removing, or otherwise remediating or managing malicious code or malicious activity, e.g., using any of the techniques described herein.

The endpoint 102 may be any of the endpoints or other compute instances or the like described herein. This may, for example, include end-user computing devices, mobile devices, firewalls, gateways, servers, routers and any other computing devices or instances that might connect to an enterprise network. The endpoint 102 may generally include a security agent 106 that locally supports threat management on the endpoint 102, such as by monitoring for malicious activity, managing security components on the endpoint 102, maintaining policy compliance, and communicating with the threat management facility 108 to support integrated security protection as contemplated herein. The security agent 106 may, for example, coordinate instrumentation of the endpoint 102 to detect various event types involving various computing objects on the endpoint 102 and supervise logging of events in a data recorder 104. The security agent 106 may also or instead scan computing objects such as electronic communications or files, monitor behavior of computing objects such as executables, and so forth. The security agent 106 may, for example, apply signature-based or behavioral threat detection techniques, machine learning models (e.g., models developed by the modeling and analysis platform), or any other tools or the like suitable for detecting malware or potential malware on the endpoint 102.

The data recorder 104 may log events occurring on or related to the endpoint. This may, for example, include events associated with computing objects on the endpoint 102 such as file manipulations, software installations, and so forth. This may also or instead include activities directed from the endpoint 102, such as requests for content from Uniform Resource Locators or other network activity involving remote resources. The data recorder 104 may record data at any frequency and any level of granularity consistent with proper operation of the endpoint 102 in an intended or desired manner.

The endpoint 102 may include a filter 122 to manage a flow of information from the data recorder 104 to a remote resource such as the threat detection tools 114 of the threat management facility 108. In this manner, a detailed log of events may be maintained locally on each endpoint, while network resources can be conserved for reporting of a filtered event stream that contains information believed to be most relevant to threat detection. The filter 122 may also or instead be configured to report causal information that causally relates collections of events to one another. In general, the filter 122 may be configurable so that, for example, the threat management facility 108 can increase or decrease the level of reporting based on a current security status of the endpoint, a group of endpoints, the enterprise network, and the like. The level of reporting may also or instead be based on currently available network and computing resources, or any other appropriate context.

In another aspect, the endpoint 102 may include a query interface 124 so that remote resources such as the threat management facility 108 can query the data recorder 104 remotely for additional information. This may include a request for specific events, activity for specific computing objects, or events over a specific time frame, or some combination of these. Thus, for example, the threat management facility 108 may request all changes to the registry of system information for the past forty-eight hours, all files opened by system processes in the past day, all network connections or network communications within the past hour, or any other parametrized request for activities monitored by the data recorder 104. In another aspect, the entire data log, or the entire log over some predetermined window of time, may be requested for further analysis at a remote resource.

It will be appreciated that communications among third party services 120, a threat management facility 108, and one or more endpoints such as the endpoint 102 may be facilitated by using consistent naming conventions across products and machines. For example, the system 100 may usefully implement globally unique device identifiers, user identifiers, application identifiers, data identifiers, Uniform Resource Locators, network flows, and files. The system may also or instead use tuples to uniquely identify communications or network connections based on, e.g., source and destination addresses and so forth.

According to the foregoing, a system disclosed herein includes an enterprise network, an endpoint coupled to the enterprise network, and a threat management facility coupled in a communicating relationship with the endpoint and a plurality of other endpoints through the enterprise network. The endpoint may have a data recorder that stores an event stream of event data for computing objects, a filter for creating a filtered event stream with a subset of event data from the event stream, and a query interface for receiving queries to the data recorder from a remote resource, the endpoint further including a local security agent configured to detect malware on the endpoint based on event data stored by the data recorder, and further configured to communicate the filtered event stream over the enterprise network. The threat management facility may be configured to receive the filtered event stream from the endpoint, detect malware on the endpoint based on the filtered event stream, and remediate the endpoint when malware is detected, the threat management facility further configured to modify security functions within the enterprise network based on a security state of the endpoint.

The threat management facility may be configured to adjust reporting of event data through the filter in response to a change in the filtered event stream received from the endpoint. The threat management facility may be configured to adjust reporting of event data through the filter when the filtered event stream indicates a compromised security state of the endpoint. The threat management facility may be configured to adjust reporting of event data from one or more other endpoints in response to a change in the filtered event stream received from the endpoint. The threat management facility may be configured to adjust reporting of event data through the filter when the filtered event stream indicates a compromised security state of the endpoint. The threat management facility may be configured to request additional data from the data recorder when the filtered event stream indicates a compromised security state of the endpoint. The threat management facility may be configured to request additional data from the data recorder when a security agent of the endpoint reports a security compromise independently from the filtered event stream. The threat management facility may be configured to adjust handling of network traffic at a gateway to the enterprise network in response to a predetermined change in the filtered event stream. The threat management facility may include a machine learning model for identifying potentially malicious activity on the endpoint based on the filtered event stream. The threat management facility may be configured to detect potentially malicious activity based on a plurality of filtered event streams from a plurality of endpoints. The threat management facility may be configured to detect malware on the endpoint based on the filtered event stream and additional context for the endpoint.

The data recorder may record one or more events from a kernel driver. The data recorder may record at least one change to a registry of system settings for the endpoint. The endpoints may include a server, a firewall for the enterprise network, a gateway for the enterprise network, or any combination of these. The endpoint may be coupled to the enterprise network through a virtual private network or a wireless network. The endpoint may be configured to periodically transmit a snapshot of aggregated, unfiltered data from the data recorder to the threat management facility for remote storage. The data recorder may be configured to delete records in the data recorder corresponding to the snapshot in order to free memory on the endpoint for additional recording.

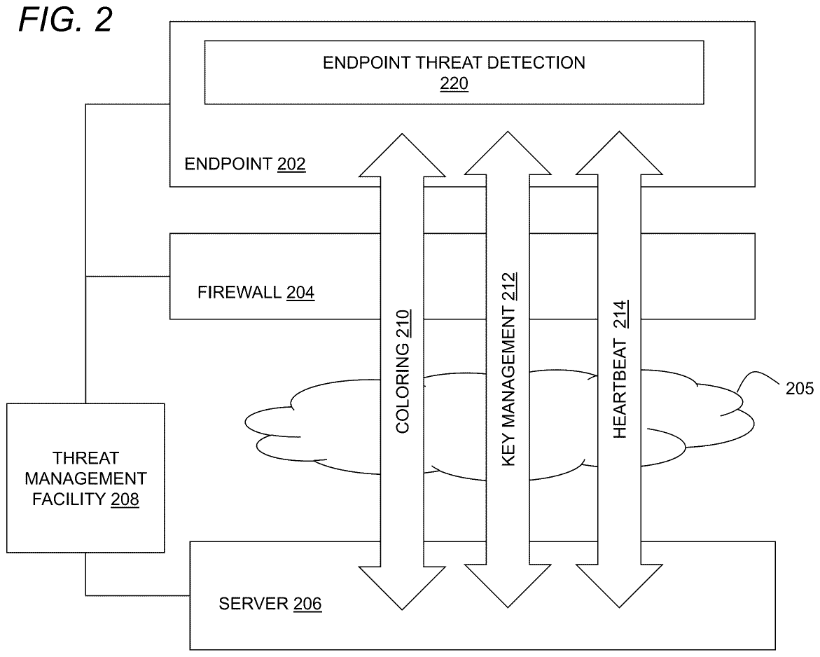

FIG. 2 illustrates a threat management system. In general, the system may include an endpoint 202, a firewall 204, a server 206 and a threat management facility 208 coupled to one another directly or indirectly through a data network 205, all as generally described above. Each of the entities depicted in FIG. 2 may, for example, be implemented on one or more computing devices such as the computing device described herein. A number of systems may be distributed across these various components to support threat detection, such as a coloring system 210, a key management system 212 and a heartbeat system 214, each of which may include software components executing on any of the foregoing system components, and each of which may communicate with the threat management facility 208 and an endpoint threat detection agent 220 executing on the endpoint 202 to support improved threat detection and remediation.

The coloring system 210 may be used to label or color software objects for improved tracking and detection of potentially harmful activity. The coloring system 210 may, for example, label files, executables, processes, network communications, data sources and so forth with any suitable information. A variety of techniques may be used to select static and/or dynamic labels for any of these various software objects, and to manage the mechanics of applying and propagating coloring information as appropriate. For example, a process may inherit a color from an application that launches the process. Similarly, a file may inherit a color from a process when it is created or opened by a process, and/or a process may inherit a color from a file that the process has opened. More generally, any type of labeling, as well as rules for propagating, inheriting, changing, or otherwise manipulating such labels, may be used by the coloring system 210 as contemplated herein.

The key management system 212 may support management of keys for the endpoint 202 in order to selectively permit or prevent access to content on the endpoint 202 on a file-specific basis, a process-specific basis, an application-specific basis, a user-specific basis, or any other suitable basis in order to prevent data leakage, and in order to support more fine-grained and immediate control over access to content on the endpoint 202 when a security compromise is detected. Thus, for example, if a particular process executing on the endpoint is compromised, or potentially compromised or otherwise under suspicion, keys to that process may be revoked in order to prevent, e.g., data leakage or other malicious activity.

The heartbeat system 214 may be used to provide periodic or aperiodic information from the endpoint 202 or other system components about system health, security, status, and so forth. A heartbeat may be encrypted or plaintext, or some combination of these, and may be communicated unidirectionally (e.g., from the endpoint 202 to the threat management facility 208) or bidirectionally (e.g., between the endpoint 202 and the server 206, or any other pair of system components) on any useful schedule.

In general, these various monitoring and management systems may cooperate to provide improved threat detection and response. For example, the coloring system 210 may be used to evaluate when a particular process is potentially opening inappropriate files based on an inconsistency or mismatch in colors, and a potential threat may be confirmed based on an interrupted heartbeat from the heartbeat system 214. The key management system 212 may then be deployed to revoke keys to the process so that no further files can be opened, deleted, or otherwise modified. More generally, the cooperation of these systems enables a wide variety of reactive measures that can improve detection and remediation of potential threats to an endpoint.

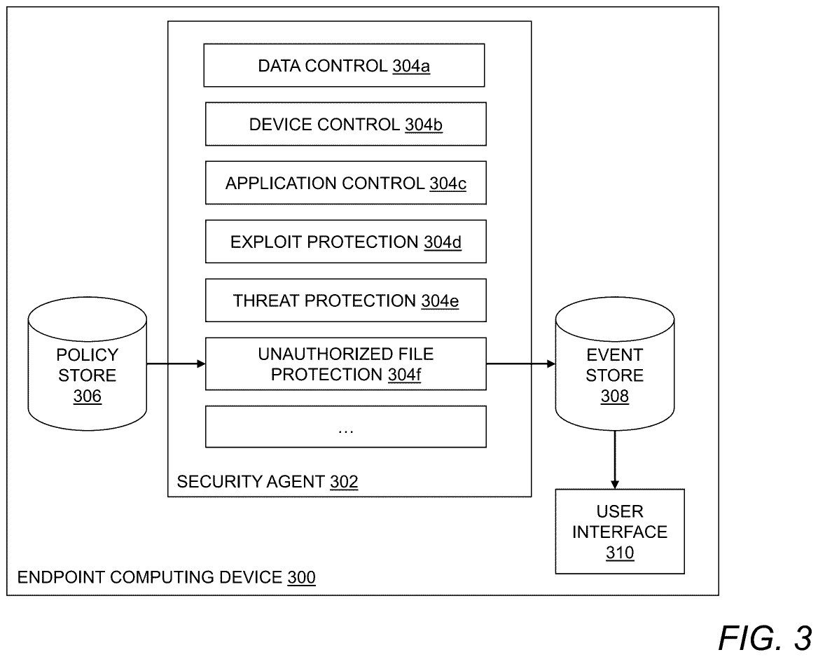

FIG. 3 is a block diagram of an endpoint computing device 300. The endpoint computing device 300 may be executing an operating system, such as Microsoft® Windows® 11 available from Microsoft Corp. of Redmond, Washington. According to general computing principles, the operating system may include any system software that manages computer hardware and software resources and provides common service for computer programs such as input, output, memory allocation, file storage, and so forth. As described previously, the endpoint 300 includes a security agent 302 that supports threat management on the endpoint 300, such as by monitoring for malicious activity, managing security components on the endpoint 102, maintaining policy compliance, and communicating with the threat management facility 108 to support integrated security protection as contemplated herein. The security agent 302 includes a plurality of endpoint protection layers 304a-304f that are configured to perform certain threat detection operations, threat management operations, and/or threat remediation operations on the endpoint 300. In some implementations, the security agent 302 includes a data control layer 304a, a device control layer 304b, an application control layer 304c, an exploit protection layer 304d, a threat protection layer 304e, and an unauthorized file protection layer 304f. As will be described in greater detail below, the endpoint protection layers 304a-304f can be configured to collaborate with each other (e.g., exchange data, enable or disable functional features of individual layers 304a-304f based upon the status of operation of other layers, etc.) to achieve integrated security protection. It should be appreciated that there may be other protection layers included in the security agent 302, in addition to the protection layers 304a-304f depicted in FIG. 3. The unauthorized file protection layer 304f is coupled to a policy store 306 and an event store 308. The event store 308 is further coupled to a user interface 310.

In some implementations, the policy store 306 is configured to receive and store data and metadata associated with one or more security policies from a remote computing device, such as threat management facility 108 of FIG. 1. As can be appreciated, an enterprise may generate one or more security policies for control and management of a plurality of endpoint computing devices (e.g., endpoint 300) that are part of the enterprise's computing ecosystem. A security policy can define specific rules, settings, and other configuration attributes that are transmitted from a central management facility to each of the endpoints for storage (e.g., in a policy store), and the endpoint can apply the security policy to activate one or more security protection features. In one example, the security agent 302 can retrieve a security policy from policy store 306 and process the security policy to initiate unauthorized file protection on the endpoint 300 via the unauthorized file protection layer 304f.

In some implementations, the event store 308 is configured to receive and store data and metadata from the unauthorized file protection layer 304f of the security agent 302. As an example, the unauthorized file protection layer 304f can detect one or more file operations (e.g., file change operations and/or file execution operations) that are initiated by the operating system of the endpoint 300. As will be described in greater detail below, depending upon the mode of unauthorized file protection that is currently applied to the endpoint 300, the unauthorized file protection layer 304f can be configured to write detected file operation events to the event store 308. In some implementations, the user interface 310 of the endpoint computing device 300 can be configured to retrieve one or more file operation events from the event store 308 and, e.g., display the file operation events to a user of the endpoint 300 (via a toast message, an alert window, or other type of visual notification). The user of the endpoint 300 is thereby notified of certain file operation events that are occurring on the endpoint 300, including but not limited to file change operations and/or file execution operations that are unauthorized in view of an applicable security policy.

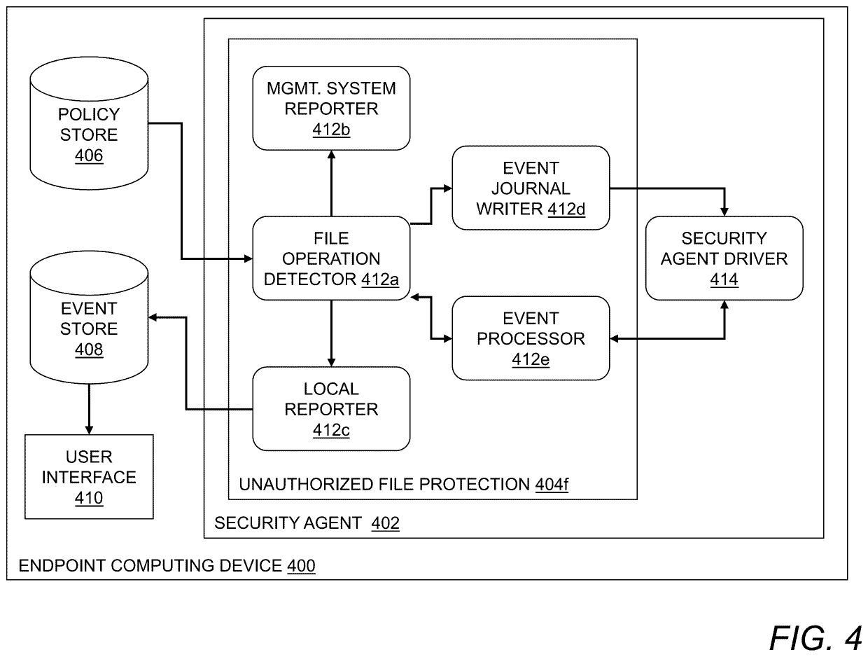

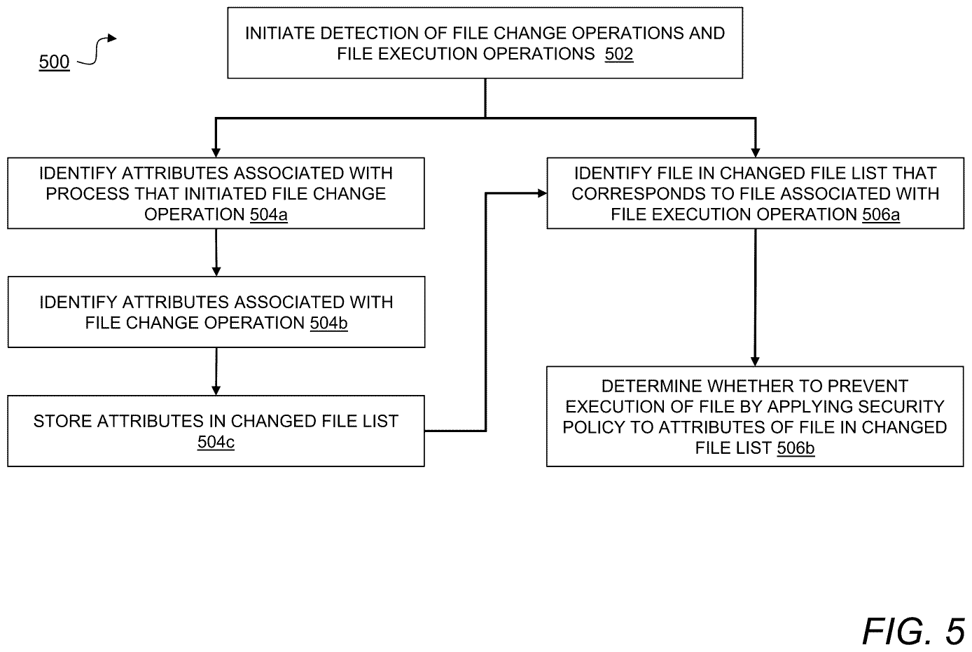

FIG. 4 is a block diagram of an endpoint computing device 400 showing a detailed view of the unauthorized file protection layer 404f of security agent 402. The unauthorized file protection layer 404f includes a file operation detector 412a, a management system reporter 412b, a local reporter 412c, an event writer 412d, and an event processor 412e. The event writer 412d and the event processor 412e are coupled to a security agent driver 414. FIG. 5 is a flow diagram of a method 500 for hardening an endpoint computing device, according to an embodiment. The method 500 may be performed by one or more systems, devices, and/or components illustrated in FIGS. 1-4 and is discussed by way of reference thereto.

At block 502, the method may include initiating detection of file change operations and detection of file execution operations in an operating system on an endpoint computing device (i.e., endpoint 400). In some implementations, the file operation detector 412a is configured to receive a security policy from policy store 406 and process the security policy to enable or disable one of a plurality of operational modes for the detection of file change operations and/or file execution operations on the endpoint 400 as described herein. Generally, the security policy may be defined to enable or disable a specific operational mode for the unauthorized file protection layer 404f, where each operational mode may comprise different rules, configurations, and/or actions for detecting file operations on the endpoint 400 as well as rules for carrying out responsive actions based upon the detected file operations.

In some implementations, the operational modes can include, but are not limited to, a block all file changes mode, a block unauthorized file changes mode, a block unauthorized file executions mode, a monitoring mode, and a maintenance mode. When the block all file changes mode is enabled on the endpoint 400, the unauthorized file protection layer 404f is configured to prevent any file change operations from being performed on files (i.e., Portable Executable (PE) files) by any operating system processes. The unauthorized file protection layer 404f is also configured to generate events corresponding to detection of file change operations for consumption by other components of the endpoint 400 as described herein.

When the block unauthorized file changes mode is enabled on the endpoint 400, the unauthorized file protection layer 404f is configured to prevent any file change operations from being performed on files unless the operations are performed by trusted operating system processes (or their descendants). The unauthorized file protection layer 404f is also configured to generate events corresponding to detection of unauthorized file change operations for consumption by other components of the endpoint 400 as described herein. In some implementations, file execution operations are not prevented in this operational mode.

When the block unauthorized file executions mode is enabled on the endpoint 400, the unauthorized file protection layer 404f is configured to prevent any file execution operations from being performed on changed files unless those changes were performed by trusted operating system processes (or their descendants). The unauthorized file protection layer 404f is also configured to generate events corresponding to detection of unauthorized file execution operations for consumption by other components of the endpoint 400 as described herein. In some implementations, file change operations on files (i.e., PE files) are allowed and tracked in this operation mode.

When the monitoring mode is enabled on the endpoint 400, the unauthorized file protection layer 404f is configured to generate events corresponding to detection of file change operations and file execution operations for consumption by other components of the endpoint 400 as described herein. In this operational mode, file change operations and file execution operations performed by operating system processes are not blocked or prevented.

When the maintenance mode is enabled on the endpoint 400, the unauthorized file protection layer 404f is temporarily disabled—i.e., file change operations and file execution operations are allowed and the unauthorized file protection layer 404f does not generate events corresponding to the above operations and does not otherwise track the operations. As can be appreciated, the maintenance mode may be useful when system administrators or other authorized personnel are performing software changes or upgrades to the endpoint 400. Upon completion of the maintenance activities, one of the other operational modes of the unauthorized file protection layer 404f can be re-enabled on the endpoint 400.

Also, as mentioned previously, the unauthorized file protection layer 404f can be configured to collaborate with other endpoint protection layers (i.e., layers 304a-304e of FIG. 3) in the security agent 402. In some implementations, when the monitoring mode is enabled for the unauthorized file protection layer 404f, the security agent 402 can inform the other endpoint protection layers 304a-304e that monitoring mode is active. For the duration of the monitoring mode, the other endpoint protection layers 304a-304e can be automatically elevated to execute in, e.g., aggressive mode to provide a higher level of security protection to the endpoint 400. When the maintenance is complete and the operational mode for the unauthorized file protection layer 404f is changed to resume unauthorized file operation detection, the security agent 402 can switch the other endpoint protection layers 304a-304e back to normal operation.

In another example, when one or more of the other endpoint protection layers 304a-304e detect that the endpoint device 400 is compromised (e.g., malware has been found on the endpoint), the security agent 402 can change the operational mode of the unauthorized file protection layer 404f to full lockdown, i.e., preventing any file change operations and file execution operations on the endpoint 400. When the threat has been neutralized, the security agent 402 can change the operational mode of the unauthorized file protection layer 404f back to its previous operational mode.

In another example, when a central management utility such as the threat management facility 108 has received security alerts from a certain number of other endpoint devices, the threat management facility 108 can transmit a notification to all endpoint devices in the system (including endpoint 400). Upon receiving the notification, the security agent 402 can activate an appropriate operational mode of the unauthorized file protection layer 404f to, e.g., prevent certain file change operations and/or file execution operations in view of the alert.

In some implementations, the unauthorized file protection layer 404f does not prevent certain file change operations or file execution operations from being performed; instead, those operations are handled by one or more of the other endpoint protection layers 304a-304e of the security agent. For example, certain high-reputation files on the endpoint 400 (as determined by, e.g., threat management facility 108) are not blocked from execution by the unauthorized file protection layer 404f. Instead, the unauthorized file protection layer 404f delegates this function to the application control layer 304c of the security agent 402. In another example, files on removable media (e.g., thumb drives, disks) coupled to the endpoint 400 are not blocked from execution by the unauthorized file protection layer 404f. Instead, the unauthorized file protection layer 404f delegates this function to the device control layer 304b of the security agent 402. In yet another example, files on remote file shares connected to the endpoint 400 are always blocked from execution based on a setting in the security policy. Therefore, the unauthorized file protection layer 404f does not need to take any action in this regard.

In some implementations, in addition to providing rules and settings to enable a particular operational mode for the unauthorized file protection layer 404f, the security policy stored in policy store 406 can define certain optional configuration parameters that can be applied by the unauthorized file protection layer 404f when evaluating file change operations and file execution operations as described herein. The optional configuration parameters can relate to specific files, folders, and/or operating system processes that are authorized to perform file operations, or blocked from performing file operations, on the endpoint 400. For example, the optional configuration parameters can configure the unauthorized file protection layer 404f to block execution of all files from shared folders and/or from user download folders. In another example, the optional configuration parameters can explicitly authorize the execution of certain files on the endpoint 400. In this example, the optional configuration parameters include an allowed list that identifies, e.g., files that are authorized to execute based upon their file path, folder path, or file checksum. In yet another example, the optional configuration parameters can explicitly block the execution of certain files on the endpoint 400. In this example, the optional configuration parameters include a block list that identifies, e.g., files that are blocked from execution based upon their file path, folder path, or file checksum. In yet another example, the optional configuration parameters can explicitly identify trusted operating system processes that are authorized to carry out file change or execution operations on the endpoint 400. In this example, the optional configuration parameters include a trusted process list that identifies, e.g., processes that can perform file operations by their file path, folder path, or checksum.

In yet another example, certain storage areas may be used as file storage only and the files stored therein are not expected to be executed. In this example, an entire storage area or an entire disk can be added to the block list of a security policy to ensure that file executions from these areas/disks are unconditionally prevented. In some implementations, the block list is shared with the other endpoint protection layers 304a-304e that can use the block list to skip scanning and/or tracking of certain files in those areas. In some implementations, the block list is shared with a behavioral threat protection function of the security agent 402 which can use the blocked areas to deploy decoy files and monitor block events reported by the unauthorized file protection layer 404f to detect suspicious behavior.

When determining whether to prevent a particular file operation, the unauthorized file protection layer 404f can analyze the security policy to determine if there are any optional configuration parameters that affect its determination.

In some implementations, security agent driver 414 is configured to capture all file operations executed in an operating system of the endpoint 400 and transmit the file operations to file operation detector 412a via event processor 412e. File operation detector 412a receives the file operations and determines whether the file operations are file change operations or file execution operations. Upon detecting a file change operation or a file execution operation, the file operation detector 412a can transmit an event to the management system reporter 412b. As an example, when the unauthorized file protection layer 404f is in a ‘block’ operational mode (e.g., block all file changes/executions, block unauthorized file changes/executions, block unauthorized executions) or a monitoring operational mode, the file operation detector 412a can detect a file change operation or a file execution operation initiated by the operating system and transmit a corresponding event to the management system reporter 412b. The management system reporter 412b can be configured to forward the event to, e.g., threat management facility 108 for analysis. In some implementations, the management system reporter 412b generates a structured data file (e.g., XML) that contains data and metadata associated with the event received from the file operation detector 412a and transmits the structured data file to the threat management facility 108. The threat management facility 108 can be configured to analyze an incoming event or a plurality of incoming events from management system reporter 412b and perform one or more corresponding actions, such as generating an alert or report, or initiating one or more changes to an existing security policy based upon the event.

In some implementations, the threat management facility 108 can include a remote policy administration function that receives the structured data file from the management system reporter 412b and determines whether one or more of the file change operations or file execution operations contained therein should be allowed. For example, the threat management facility 108 can analyze the structured data and determine that the corresponding operation(s) are allowable. The threat management facility 108 can transmit instructions to the endpoint 400 to allow the file change operation and/or allow the file execution operation.

In some implementations, upon detecting a file change operation or a file execution operation, the file operation detector 412a can transmit an event to the local reporter 412c. As an example, when the unauthorized file protection layer 404f is in a ‘block’ operational mode (e.g., block all file changes/executions, block unauthorized file changes/executions, block unauthorized executions), the file operation detector 412a can detect a file change operation or a file execution operation initiated by the operating system and transmit a corresponding event to the local reporter 412c. The local reporter 412c can be configured to store the event in the event store 408. In some implementations, the local reporter 412c generates a structured data file (e.g., XML) that contains data and metadata associated with the event received from the file operation detector 412a and transmits the structured data file to the event store 408. The user interface 410 can be configured to retrieve events from the event store 408 for display to a user of the endpoint 400 (as described above with respect to FIG. 3).

In some implementations, upon detecting a file change operation or a file execution operation, the file operation detector 412a can transmit an event to the event journal writer 412d. The event journal writer 412d can be configured to analyze the event received from the file operation detector 412a and generate structured data (e.g., JSON) that contains data and metadata associated with the event received from the file operation detector 412a. The event journal writer 412d transmits the structured data to the security agent driver 414 which is configured to store the event data in a repository coupled to, e.g., modeling and analysis platform 128, to support further investigation of security issues, creation or refinement of threat detection models or algorithms, review and analysis of security breaches, and so forth. As an example, when the unauthorized file protection layer 404f is in a ‘block’ operational mode (e.g., block all file changes/executions, block unauthorized file changes/executions, block unauthorized executions) or a monitoring operational mode, the security agent driver 414 can transmit corresponding file operation event data to modeling and analysis platform 128. In some implementations, modeling and analysis platform 128 can be configured to provide the event data to, e.g., threat management facility 108 as part of a live threat discovery mode to quickly identify threats and initiate neutralization actions and/or remediation actions.

As can be appreciated, the volume of file change operations or file execution operations that are captured and tracked by the unauthorized file protection layer 404f for a given endpoint 400 may result in a significant number of events being transmitted to the threat management facility 108 or the modeling and analysis platform 128. In order to reduce the amount of potential ‘noise’ that is received by the threat management facility 108 or the modeling and analysis platform 128, in some implementations the unauthorized file protection layer 404f can be configured to reduce or limit the number of events that are transmitted by either the management system reporter 412b or the event journal reporter 412d. For example, the unauthorized file protection layer 404f can be configured to transmit no more than one event file for a defined time period (e.g., 24 hours). In another example, the unauthorized file protection layer 404f can be configured to transmit a maximum number of events over a defined time period (e.g., 24 hours). In yet another example, the unauthorized file protection layer 404f can be configured with flags or policy settings to reduce the volume of event transmissions.

In some implementations, upon detecting a file change operation or a file execution operation, the file operation detector 412a can transmit an event to the event processor 412e. The event processor 412e can be configured to analyze the event received from the file operation detector 412a and perform one or more actions based upon the specific operational mode that is enabled in the unauthorized file protection layer 404f. While the defined rules and configurations of each operational mode varies as described above, generally the event processor 412e can perform certain functions when a file change operation is detected by file operation detector 412a, and the event processor 412e can perform certain functions when a file execution operation is detected by file operation detector 412a.

In some implementations, the event processor 412e can receive an event from the file operation detector 412a that indicates a file change operation is detected. At block 504a, the method includes identifying one or more attributes associated with an operating system process that initiated the file change operation. For example, the event processor 412e can identify one or more attributes associated with a process executing in the operating system of the endpoint 400 that initiated the file change operation. As can be appreciated, an operating system process can maliciously (or innocuously) initiate a file change operation for one or more files on the endpoint 400. Examples of file change operations include, but are not limited to, creating a file, modifying a file, renaming a file, moving a file, deleting a file, renaming a folder, moving a folder, and creating a hardlink (e.g., a mirrored copy) of the file. Upon detecting a file change operation, the file operation detector 412a can capture, e.g., a process id (PID) associated with the operating system process that initiated the file change operation. The file operation detector 412a can transmit a corresponding event, that includes the process id, to the event processor 412e for analysis. The event processor 412e receives the event and identifies one or more attributes associated with the process that initiated the file change operation based upon, e.g., the process id included in the event. In some implementations, the event processor 412e retrieves the one or more attributes associated with the process from the operating system tasklist using the process id. Exemplary process attributes can include, but are not limited to, a file path of the process that initiated the file change operation, a folder path of the process that initiated the file change operation, a checksum of the process that initiated the file change operation, an identification of one or more other processes related to the process that initiated the file change operation. As can be appreciated, a process executed in the user space of an operating system may be related to one or more other executing processes. For example, a parent process may spawn a plurality of child processes. The event processor 412e can identify relationship(s) between processes to be included in the one or more attributes associated with the process.

At block 504b, the method includes identifying one or more associated with the file change operation, including a unique file id associated with the changed file. For example, the event processor 412e identifies one or more attributes associated with the file change operation. Upon detecting a file change operation, the file operation detector 412a can capture, e.g., a unique file id associated with the file that is the subject of the file change operation (i.e., the changed file). The file operation detector 412a can include the unique file id of the changed file in the event that is transmitted to the event processor 412e. Using the unique file id, the event processor 412e identifies one or more attributes associated with the file change operation, including but not limited to, a file format of the changed file, a file path of the changed file, a folder path of the changed file, a checksum of the changed file, and a reputation score of the changed file. In some implementations, the file format of the changed file is the Portable Executable (PE) format. Generally, the PE format is used for executables, object code, dynamic linked libraries (DLLs) and other files used in the Windows™ operating system. It should be appreciated that other file formats can be contemplated for use with the technology described herein.

As mentioned above, the event processor 412e can identify a reputation score of the changed file. In some implementations, the security policy applied to the endpoint 400 by the security agent 402 may define a reputation score associated with certain files on the endpoint 400. Generally, the reputation score corresponds to a risk level that the file may comprise or relate to malware. A higher reputation score indicates that the corresponding file is considered more trustworthy, while a lower reputation score indicates that the file is less trustworthy. The reputation score can be calculated using a number of different file characteristics, including but not limited to a digital signature of the file, a usage pattern of the file, an age of the file, a source of the file, among others.

At block 504c, the method includes storing the one or more attributes associated with the file change operation in a changed file list. In some implementations, when the event processor 412e has identified the attributes associated with the process that initiated the file change operation and the attributes associated with the file change operation, the event processor 412e can store the identified attributes associated with the file change operation in a changed file list. For example, the event processor 412e can create an entry in the changed file list that includes the unique file id of the changed file and the corresponding attributes identified for the changed file by the event processor 412e. In some implementations, the changed file list is maintained by the security agent 402 and stored locally on the endpoint 400. As will be described in greater detail below, the event processor 412e can refer to the changed file list when determining whether to allow or prevent execution of certain files on the endpoint 400. In some implementations, the changed file list does not contain any entries prior to a particular operational mode being enabled in the unauthorized file protection layer 404f. As an example, before the block all files operational mode is enabled, the changed file list may be empty. When the block all files mode is subsequently enabled on the endpoint 400, the unauthorized file protection layer 404f begins generating entries in the changed file list upon detecting file change operations as described above. In some implementations, the changed file list is deleted or cleared when the unauthorized file protection layer 404f is changed to a different operational mode on the endpoint 400 or when a current operational mode of the unauthorized file protection layer 404f is disabled on the endpoint 400. For example, the operational mode of the unauthorized file protection layer 404f can be changed from a block all files mode to a maintenance mode. Upon changing to the maintenance mode, the unauthorized file protection layer 404f suspends the detection of file change operations and no new entries are added to the existing changed file list for the duration of the maintenance mode. Then, when the block all files mode is re-enabled on the endpoint 404, the unauthorized file protection layer 404f resumes the detection of file change operations and resumes adding new entries the changed file list to capture changes to files occurring from that point forward.

In some implementations, the changed file list contains unique id values associated with the changed file. The id can be used to look up other attributes associated with the file, such as file path, folder path, checksum, reputation score, and so forth. An example of an entry in the changed file list is:
sfid=“3c623670000000000000100000000000108d00000000bc010000000000000000”

At block 506a, the method includes identifying a file in the changed file list that corresponds to a file associated with the file execution operation. In some implementations, the event processor 412e can receive an event from the file operation detector 412a that indicates a file execution operation is detected. For example, a process running in the operating system of the endpoint 400 may initiate execution of a particular file. Upon detecting a file execution operation, the file operation detector 412a can capture, e.g., a PID associated with the operating system process that initiated the file execution operation and/or a unique file id associated with the file that is being executed. The file operation detector 412a can transmit a corresponding event, that includes the PID and/or the unique file id, to the event processor 412e for analysis. The event processor 412e receives the event and identifies a file in the changed file list that corresponds to, e.g., the unique file id of the file being executed. In some implementations, the event processor 412e identifies the file in the changed file list by comparing the unique file id received in the event from the file operation detector 412a to the list of unique file ids stored in the changed file list.

At block 506b, the method includes determining whether to prevent execution of the file by applying a security policy to the one or more attributes in the changed file list that correspond to the identified file. In some implementations, the event processor 412e determines whether to prevent the operating system from executing the file by applying the security policy (from policy store 406) to the one or more attributes in the changed file list that correspond to the identified file. As mentioned above, the security policy can include specific rules, settings, and other configuration attributes associated with an operational mode for unauthorized file protection that is enabled on the endpoint 400. The event processor 412e applies the security policy to determine whether to prevent execution of the identified file. As one example, the unauthorized file protection layer 404f may be enabled in a block unauthorized file executions mode. In this operational mode, the security policy dictates that any execution of a file included in the changed file list should be prevented unless the file changes were performed by a trusted process (or descendants of a trusted process). The event processor 412e can analyze the attributes associated with the identified file in the changed file list, in view of the security policy, to determine that the changes to the file were not performed by a trusted process or its descendants. As a result, the event processor 412e determines that execution of the file should be prevented. In some implementations, the event processor 412e transmits instructions to the security agent driver 414 to prevent the particular file execution operation for this file. The security agent driver 414 instructs the operating system of the endpoint 400 to prevent execution of the file.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of t he following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the technology as defined by the following claims, which are to be interpreted in the broadest sense allowable by law.

What is claimed is:

1. A system for hardening an endpoint computing device, the system comprising:
one or more computer-readable media having computer-executable instructions stored thereon; and
one or more processors that, having executed the computer-executable instructions, are configured to:
initiate detection of file change operations and detection of file execution operations in an operating system on an endpoint computing device;
when a file change operation is detected:
identify one or more attributes associated with a process that initiated the file change operation,
identify one or more attributes associated with the file change operation, the attributes including a unique file id associated with the changed file,
store the one or more attributes associated with the file change operation in a changed file list; and
when a file execution operation is detected:
identify a file in the changed file list that corresponds to a file associated with the file execution operation, and
determine whether to prevent execution of the file by applying a security policy to the one or more attributes in the changed file list that correspond to the identified file.

2. The system of claim 1, wherein the file change operations comprise creating a file, modifying a file, renaming a file, moving a file, deleting a file, renaming a folder, moving a folder, and creating a hardlink.

3. The system of claim 2, wherein the one or more attributes associated with the file change operation further comprise one or more of: a file format of the changed file, a file path of the changed file, a folder path of the changed file, a checksum of the changed file, and a reputation score of the changed file.

4. The system of claim 3, wherein the file format of the changed file comprises a Portable Executable (PE) file format.

5. The system of claim 1, wherein the one or more attributes associated with the process that initiated the file change operation comprise one or more of: a file path of the process that initiated the file change operation, a folder path of the process that initiated the file change operation, a checksum of the process that initiated the file change operation, an identification of one or more other processes related to the process that initiated the file change operation.

6. The system of claim 1, wherein the security policy is received from a remote policy administration computing device for storage in a policy store on the endpoint computing device.

7. The system of claim 6, wherein the endpoint computing device is configured to (i) transmit one or more events associated with the detection of file change operations to the remote policy administration computing device and (ii) allow the file change operation and/or allow the file execution operation based upon instructions received from the remote policy administration computing device.

8. The system of claim 1, wherein the endpoint computing device is configured to initiate one of a plurality of operational modes, each operational mode comprising one or more rules for adjusting the detection of file change operations or adjusting the detection of file execution operations.

9. The system of claim 8, wherein the operational modes comprise a block all file changes mode, a block unauthorized file changes mode, a block unauthorized file executions mode, a monitoring mode, and a maintenance mode.

10. The system of claim 9, wherein when one or more other protection layers on the endpoint computing device detect a threat on the endpoint computing device, the endpoint device is configured to automatically initiate the block all file changes mode until the threat is resolved.

11. The system of claim 9, wherein upon initiation of the maintenance mode, the endpoint computing device is configured to suspend the detection of file change operations and prevent new files from being added to the changed file list.

12. The system of claim 10, wherein one or more other system protection layers on the endpoint computing device automatically increase a level of protection for the endpoint computing device upon initiation of the maintenance mode.

13. A method of hardening an endpoint computing device, the method comprising:
initiating, in an operating system on an endpoint computing device, detection of file change operations and detection of file execution operations in an operating system on an endpoint computing device;
when a file change operation is detected:
identify one or more attributes associated with a process that initiated the file change operation,
identify one or more attributes associated with the file change operation, the attributes including a unique file id associated with the changed file,
store the one or more attributes associated with the file change operation in a changed file list; and
when a file execution operation is detected:
identify a file in the changed file list that corresponds to a file associated with the file execution operation, and
determine whether to prevent execution of the file by applying a security policy to the one or more attributes in the changed file list that correspond to the identified file.

14. The method of claim 13, wherein the file change operations comprise creating a file, modifying a file, renaming a file, moving a file, deleting a file, renaming a folder, moving a folder, and creating a hardlink.

15. The method of claim 14, wherein the one or more attributes associated with the file change operation further comprise one or more of: a file format of the changed file, a file path of the changed file, a folder path of the changed file, a checksum of the changed file, and a reputation score of the changed file.

16. The method of claim 15, wherein the file format of the changed file comprises a Portable Executable (PE) file format.

17. The method of claim 13, wherein the one or more attributes associated with the process that initiated the file change operation comprise one or more of: a file path of the process that initiated the file change operation, a folder path of the process that initiated the file change operation, a checksum of the process that initiated the file change operation, an identification of one or more other processes related to the process that initiated the file change operation.

18. The system of claim 13, further comprising receiving the security policy from a remote policy administration computing device for storage in a policy store on the endpoint computing device.

19. The method of claim 18, further comprising:
transmitting, by the endpoint computing device, one or more events associated with the detection of file change operations to the remote policy administration computing device; and
allowing, by the endpoint computing device, the file change operation and/or allow the file execution operation based upon instructions received from the remote policy administration computing device.

20. The method of claim 13, further comprising initiating, by the endpoint computing device, one of a plurality of operational modes, each operational mode comprising one or more rules for adjusting the detection of file change operations or adjusting the detection of file execution operations.

21. The method of claim 20, wherein the operational modes comprise a block all file changes mode, a block unauthorized file changes mode, a block unauthorized file executions mode, a monitoring mode, and a maintenance mode.

22. The method of claim 21, wherein when one or more other protection layers on the endpoint computing device detect a threat on the endpoint computing device, the endpoint automatically initiates the block all file changes mode until the threat is resolved.

23. The method of claim 21, wherein upon initiation of the maintenance mode, the endpoint computing device suspends the detection of file change operations and prevents new files from being added to the changed file list.

24. The method of claim 23, wherein one or more other system protection layers on the endpoint computing device automatically increase a level of protection for the endpoint computing device upon initiation of the maintenance mode.
